(19) United States
(12) Patent Application Publication
(10) Pub. No.: US 2022/0196053 A1
(43) Pub. Date: Jun. 23, 2022

(54) A LOCKING DEVICE FOR KNOCKDOWN FURNITURE

(71) Applicant: S.P.S. INTERTECH CO., LTD., Chachoengsao (TH)

(72) Inventor: Werasak SERMPRAPHASILP, Bangkok (TH)

(73) Assignee: S.P.S. INTERTECH CO., LTD., Chachoengsao (TH)

(21) Appl. No.: 17/604,699

(22) PCT Filed: Apr. 13, 2020
(86) PCT No.: PCT/TH2020/000022

§ 371 Date: Oct. 18, 2021

(30) Foreign Application Priority Data
Apr. 18, 2019 (TH) 1901002309

(51) Int. Cl. F16B 12/14

(52) U.S. Cl. CPC F16B 12/14

(57) ABSTRACT

The present invention relates to a locking device for knockdown furniture having an anchor plug for fastening to one furniture part and a fastening screw for fastening to the other furniture part which is assembled to said one furniture part. The anchor plug is fastened to the one furniture part such that the anchor plug is embedded into said one furniture part with a surface of the anchor plug being slightly lower than the surface of said one furniture part and the anchor plug has a tapered portion with an inclination angle. The fastening screw is fastened to the other furniture part such that the fastening screw is embedded into said other furniture part with a portion of the fastening screw extending from the surface of said other furniture part.

### TECHNICAL FIELD

Engineering related to a locking device for knockdown furniture

### BACKGROUND OF THE INVENTION

Commonly used knockdown furniture have different characteristics. They are equipped with a locking device or a connection system for locking or assembling each furniture part together to form a knockdown furniture. Such locking device or connection system has different characteristics which results in different assembly of each furniture part.

FIG. 9 shows the conventional assembly steps of knockdown furniture using a locking device consisting of a lock, a fastening screw and a dowel. The lock consists of a head part having a groove for screwing with a screwdriver and a locking portion. The fastening screw consists of a head part, a non-threaded part, a stopper and a threaded part. Each furniture part is assembled together by fastening the fastening screw to a hole drilled on the first furniture part with a portion of the fastening screw extending from said furniture part, fastening the dowel to the hole drilled on the second furniture part with a portion of the dowel extending from said furniture part, assembling both furniture parts such that the extending portion of the dowel is inserted into the hole drilled on the first furniture part and the extending portion of the fastening screw inserted into the hole drilled on the second furniture part, inserting the lock into another hole drilled on the second furniture part and screwing the lock with the screwdriver to lock it to the fastening screw.

According to the said conventional assembly steps of knockdown furniture, many assemble and disassemble steps are required. The assembly and disassembly of furniture parts require a number of equipment to screw or fasten the lock and the fastening screw, therefore causing inconvenience to operators and users. Moreover, if the assembly and disassembly of furniture parts are frequently performed, the furniture could be damaged easily and the strength of the furniture assembled may be affected, for example.

Furthermore, patent documents disclosing a connection system for assembling or connecting two furniture parts are as follows.

PCT publication no. WO 2020/027712 A1 discloses a connection system for connecting a first furniture part to a second furniture part.

The first furniture part comprises a primary dowel and two secondary dowels, each dowel extending from the first furniture part along a longitudinal direction towards a free end of the dowel and each dowel having at least one neck portion.

The second furniture part comprises a primary recess and two secondary recesses. The primary recess is disposed relative to the primary dowel and the two secondary recesses are disposed relative to the two secondary dowels. Each recess comprises an insertion portion and a locking portion arranged one after the other along a transverse direction.

The insertion portion is configured to receive the dowel by a motion of the first furniture part along the longitudinal direction relative to the second furniture part. The dowel is configured to be transferred from the insertion portion to the locking portion of the recesses by a motion of the first furniture part along the transverse direction relative to the second furniture part. The locking portion is configured to engage the neck portion of the dowel to prevent removal of the dowel from the locking portion in a direction opposite to the longitudinal direction.

According to WO 2020/027712 A1, the primary dowel and secondary dowels are configured as an extending core with undulation surface which is attached on the first furniture part and the primary recess and secondary recesses are configured as a recess with undulation surface which is formed in the second furniture part. An expensive, specific tool is therefore required to make such primary and secondary dowels and recesses which results in a higher cost of knockdown furniture production. Moreover, the making of such primary and secondary dowels and recesses cannot be applied to certain knockdown wood furniture such as particle board.

Said locking device and connection system do not include the locking device for knockdown furniture according to the invention, which will be further described. For example, they do not include a component called anchor plug which comprises various unique parts and a lock between the anchor plug and a fastening screw which provides various technical advantages.

### SUMMARY OF THE INVENTION

The present invention relates to a locking device for furniture. Particularly, the present invention relates to a locking device for knockdown furniture.

The locking device for knockdown furniture according to the present invention comprises:

an anchor plug for fastening to one furniture part, and

a fastening screw for fastening to the other furniture part which is assembled to said one furniture part

characterized in that
the anchor plug is fastened to the one furniture part such that the anchor plug is embedded into said one furniture part with a surface of the anchor plug being slightly lower than the surface of the one furniture part and the anchor plug having a tapered portion with an inclination angle,
the fastening screw is fastened to the other furniture part such that the fastening screw is embedded into said other furniture part with a portion of the fastening screw extending from the surface of said other furniture part, the fastening screw having a tapered portion with an inclination angle which corresponds to the tapered portion with an inclination angle at the anchor plug, and
said one furniture part and other furniture part are assembled together such that the anchor plug and the fastening screw are locked together by moving either said one furniture part or other furniture part to allow the anchor plug and the fastening screw to be locked such that they are against each other.

An object of the present invention is to provide a locking device for knockdown furniture with improved, unique features that provides many technical advantages, i.e.

easy, convenient and quick assembly and disassembly of knockdown furniture without the use of any tool to screw the fastening screw to fasten or lock it to the anchor plug,

reduction in the knockdown furniture assembly and disassembly steps,

application to knockdown wood furniture that is particle board while maintaining high strength to tensile force, e.g. a strength to tensile force of up to 490 N, other than the application to medium density fiberboard or solid wood,

reduction in the knockdown furniture production cost, and

application to the conventional knockdown furniture production line.

### BRIEF DESCRIPTION OF THE DRAWINGS

FIG. 1 shows the locking device comprising the anchor plug and the fastening screw according to the present invention.

FIG. 2 is a perspective view of the anchor plug of the locking device according to the present invention.

FIG. 3 is a top view of the anchor plug of the locking device according to the present invention.

FIG. 4 is a bottom view of the anchor plug of the locking device according to the present invention.

FIG. 5 is a perspective view of the fastening screw of the locking device according to the present invention.

FIG. 6 shows the fastening screw in the insertion slot of the anchor plug according to the present invention.

FIG. 7 shows the fastening screw in the lock slot of the anchor plug according to the present invention.

FIG. 8 shows the assembly steps of knockdown furniture according to the present invention.

FIG. 9 shows the conventional assembly steps of knockdown furniture.

### DETAILED DESCRIPTION

The locking device for knockdown furniture according to the present invention will now be described with reference to the accompanying drawings.

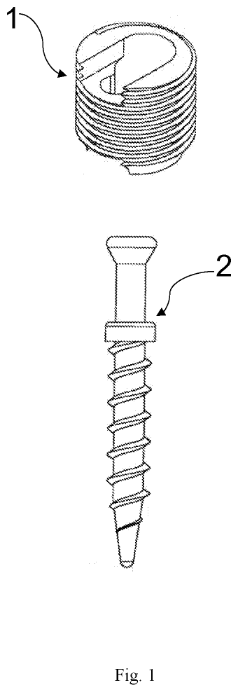

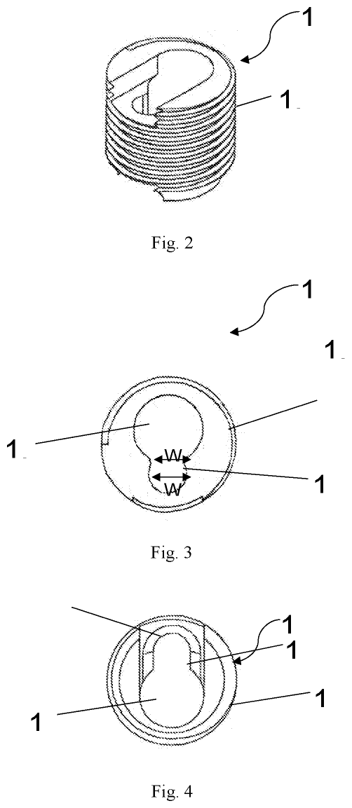

FIGS. 1 to 8 show the locking device for knockdown furniture according to an embodiment of the present invention.

According to the present invention, as shown in FIGS. 1 to 8, the locking device for knockdown furniture comprises

an anchor plug (1) for fastening to one furniture part (FP1), and

a fastening screw (2) for fastening to the other furniture part (FP2) which is assembled to said one furniture part (FP1)

characterized in that
the anchor plug (1) is fastened to the one furniture part (FP1) such that the anchor plug (1) is embedded into said one furniture part (FP1) with a surface of the anchor plug (1) being slightly lower than the surface of said one furniture part (FP1) and the anchor plug (1) having a tapered portion with an inclination angle,
the fastening screw (2) is fastened to the other furniture part (FP2) such that the fastening screw (2) is embedded into said other furniture part (FP2) with a portion of the fastening screw (2) extending from the surface of said other furniture part (FP2), the fastening screw (2) having a tapered portion with an inclination angle which corresponds to the tapered portion with an inclination angle at the anchor plug (1), and
said one furniture part (FP1) and other furniture part (FP2) are assembled together such that the anchor plug (1) and the fastening screw (2) are locked together by moving either said one furniture part (FP1) or other furniture part (FP2) to allow the anchor plug (1) and the fastening screw (2) to be locked such that they are against each other.

According to the present invention, a surface of the anchor plug (1) is 0.1-0.4 mm lower than the surface of said one furniture part (FP1), preferably 0.2-0.3 mm.

According to the above invention, a technical advantage provided is the anchor plug (1) and the fastening screw (2) can be easily locked together, making it easy, convenient and fast to assemble furniture parts without the use of any tool to screw the fastening screw (2) to fasten or lock it to the anchor plug (1).

According to the locking device for knockdown furniture of the present invention as shown in FIGS. 1-4, the anchor plug (1) comprises:

a cylindrical portion (1.1),

a threaded portion (1.2) located on an outer surface of the cylindrical portion (1.1),

an insertion slot (1.3) located inside the cylindrical portion (1.1), and

a lock slot (1.4) located inside the cylindrical portion (1.1) such that it is connected to the insertion slot (1.3),

the lock slot (1.4) having a tapered surface with an inclination angle (A), preferably a tapered surface with an inclination angle (A) of 20-40 degrees, preferably 30 degrees.

According to the locking device for knockdown furniture of the present invention, the lock slot (1.4) of the anchor plug (1) is smaller than the insertion slot (1.3) of the anchor plug (1) and a region of the lock slot (1.4) that is connected to the insertion slot (1.3) has a width (w1) that is less than a width (w2) of the lock slot (1.4), preferably
the region of the lock slot (1.4) that is connected to the insertion slot (1.3) has the width (w1) of 3-4 mm, preferably 3.2 mm, and
the lock slot (1.4) has the width (w2) of 3.5-5 mm, preferably 3.5 mm.

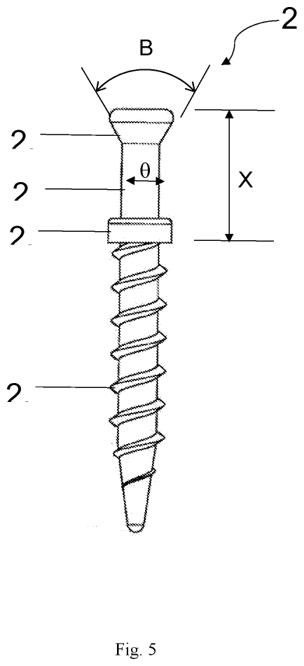

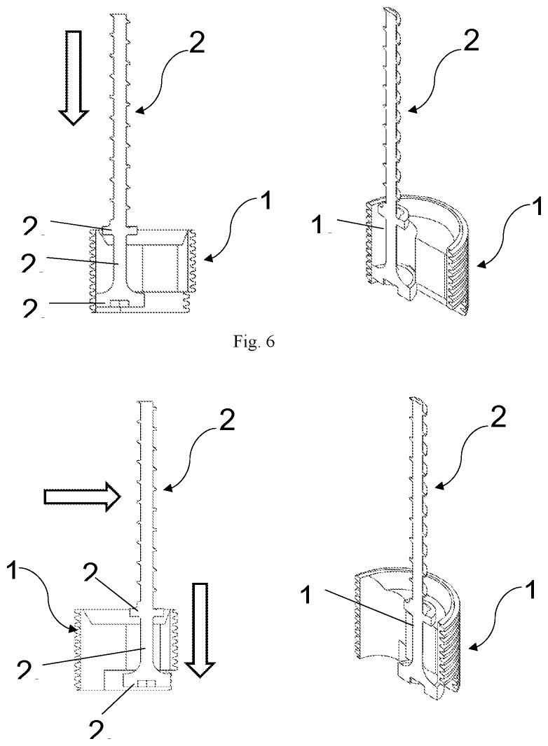

According to the locking device for knockdown furniture of the present invention as shown in FIGS. 1 and 5, the fastening screw (2) comprises:

a head portion (2.1),

a non-threaded portion (2.2) having one end connected to the head portion (2.1),

a stopper (2.3) connected to the other end of the non-threaded portion (2.2), and

a threaded portion (2.4) having one end connected to the stopper (2.3),

wherein the head portion (2.1) of the fastening screw (2) has a tapered portion with an inclination angle (B), preferably a tapered portion with an inclination angle (B) of 50-70 degrees, preferably 60 degrees, so that it corresponds to the tapered surface with the inclination angle (A) at the lock slot (1.4).

According to the invention, a technical advantage provided is the tapered portion with the inclination angle (A) on a surface of the lock slot (1.4) of the anchor plug (1) is completely attached to the tapered portion with the inclination angle (B) on a surface of the head portion (2.1) of the fastening screw (2) when the anchor plug (1) and the fastening screw (2) are locked together. The anchor plug (1) and the fastening screw (2) are therefore securely locked together and a strong knockdown furniture is obtained.

According to the locking device for knockdown furniture of the present invention, the non-threaded portion (2.2) of the fastening screw (2) has a diameter (θ) of 3-5 mm, preferably 3-4 mm, more preferably 3.5 mm, and the head portion (2.1) and the stopper (2.3) of the fastening screw (2) are spaced apart from each other by a distance (x) of 10-15 mm, preferably 12 mm.

According to the invention, a technical advantage provided is the non-threaded portion (2.2) of the fastening screw (2) is securely locked into the lock slot (1.4) of the anchor plug (1) upon assembly of the one furniture part (FP1) and the other furniture part (FP2) because the diameter (θ) of the non-threaded portion (2.2) of the fastening screw (2) is slightly greater than the width (w1) of the lock slot (1.4). This also allows the furniture assembler to know whether or not the non-threaded portion (2.2) of the fastening screw (2) is locked into the lock slot (1.4) of the anchor plug (1).

FIG. 6 shows the fastening screw (2) in the insertion slot (1.3) of the anchor plug (1). It is shown that the fastening screw (2) is moved downward to the anchor plug (1) until the head part (2.1), non-threaded portion (2.2) and stopper (2.3) of the fastening screw (2) are located in the insertion slot (1.3) of the anchor plug (1).

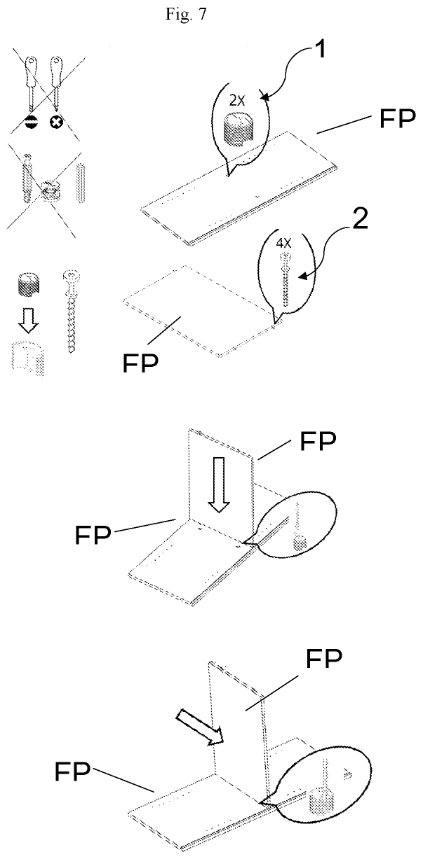

FIG. 7 shows the fastening screw (2) in the lock slot (1.4) of the anchor plug (1). It is shown that the fastening screw (2) is moved to the right and moved downward until the head part (2.1), non-threaded portion (2.2) and stopper (2.3) of the fastening screw (2) are located in the lock slot (1.4) of the anchor plug (1).

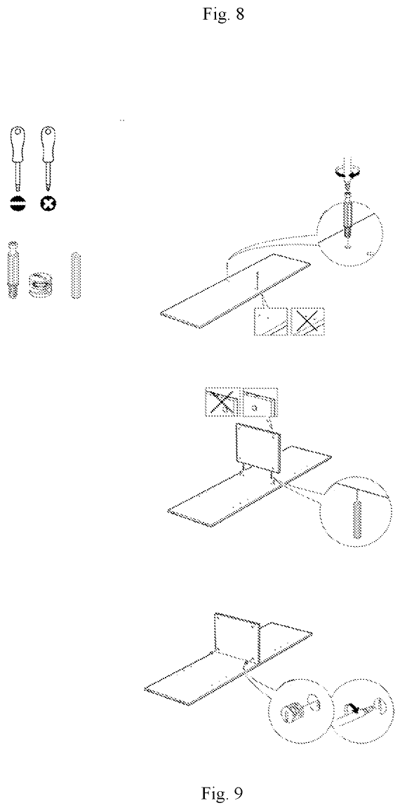

FIG. 8 is the knockdown furniture assembly steps according to the present invention which shows the knockdown furniture assembly using the locking device comprising the anchor plug (1) and the fastening screw (2) according to the present invention which have improved, unique features. Said locking device is mounted or fastened to each furniture part in advance, therefore the assembly and disassembly of knockdown furniture are easy, convenient and fast and do not require a tool for screwing the fastening screw to fasten or lock it to the anchor plug (1). Said locking device also helps to reduce the knockdown furniture assembly and disassembly steps and makes the knockdown furniture strong.

According to the locking device for knockdown furniture of the present invention, the one furniture part (FP1) and the other furniture part (FP2) are assembled together using the anchor plug (1) and the fastening screw (2) such that
the anchor plug (1) is embedded into the one furniture part (FP1) with a surface of the anchor plug (1) being slightly lower than the surface of said one furniture part (FP1), preferably 0.1-0.4 mm lower than said one furniture part (FP1), preferably 0.2-0.3 mm,
the fastening screw (2) is fastened to the other furniture part (FP2) with the threaded portion (2.4) embedded into said other furniture part (FP2) and the head portion (2.1), non-threaded portion (2.2) and stopper (2.3) are located on the surface of said other furniture part (FP2) such that the stopper (2.3) abuts against the surface of said other furniture part (FP2),
said one furniture part (FP1) and other furniture part (FP2) are assembled together with the insertion slot (1.3) of the anchor plug (1) fitting the head part (2.1), the non-threaded portion (2.2) and stopper (2.3) of the fastening screw (2) located on the surface of said other furniture part (FP2) such that the surface of the one furniture part (FP1) and the surface of said other furniture part (FP2) are attached and either said one furniture part (FP1) or other furniture part (FP2) is moved in a manner that allows the non-threaded portion (2.2) of the fastening screw (2) to be locked into the lock slot (1.4) of the anchor plug (1).

The locking device for knockdown furniture according to the present invention can be used with various types of knockdown furniture, such as particle board, medium density fiberboard and solid wood. This solves the problem found in the prior arts, for example, a connection system consisting of dowels and primary and secondary recesses disclosed in the PCT publication no. WO 2020/027712 A1 which cannot be used with certain knockdown furniture such as particle board.

According to the locking device for knockdown furniture of the present invention, the anchor plug (1) can be made of any materials, e.g. nylon, polyoxymethylene (Pom), polypropylene (PP), acrylonitrile butadiene styrene (ABS) or polyethylene (PE).

According to the locking device for knockdown furniture of the present invention, the fastening screw (2) can be made of any materials, e.g. iron, zinc or alloy.

The locking device for knockdown furniture according to the present invention comprises components with improved, unique characteristics which provide many technical advantages as described above. However, the locking device for knockdown furniture according to the present invention can be additionally altered and modified to obtain similar effects with the present invention. Such additional alteration and modification are still deemed to be within the scope of the present invention.

### BEST MODE OF THE INVENTION

Best mode of the invention is as described in the detailed description of the invention.

1. A locking device for knockdown furniture comprising:
an anchor plug (1) for fastening to one furniture part (FP1), and
a fastening screw (2) for fastening to an other furniture part (FP2) which is assembled to said one furniture part (FP1)
characterized in that
the anchor plug (1) is fastened to the one furniture part (FP1) such that the anchor plug (1) is embedded into said one furniture part (FP1) with a surface of the anchor plug (1) being slightly lower than a surface of the one furniture part (FP1) and the anchor plug (1) having a tapered portion with an inclination angle,
the fastening screw (2) is fastened to the other furniture part (FP2) such that the fastening screw (2) is embedded into said other furniture part (FP2) with a portion of the fastening screw (2) extending from a surface of said other furniture part (FP2), the fastening screw (2) having a tapered portion with an inclination angle which corresponds to the tapered portion with an inclination angle at the anchor plug (1), and
said one furniture part (FP1) and other furniture part (FP2) are assembled together such that the anchor plug (1) and the fastening screw (2) are locked together by moving either said one furniture part (FP1) or other furniture part (FP2) to allow the anchor plug (1) and the fastening screw (2) to be locked such that they are against each other,
wherein the anchor plug (1) comprising:
a cylindrical portion (1.1),
a threaded portion (1.2) located on an outer surface of the cylindrical portion (1.1),
an insertion slot (1.3) located inside the cylindrical portion (1.1), and
a lock slot (1.4) located inside the cylindrical portion (1.1) such that it is connected to the insertion slot (1.3), the lock slot (1.4) having a tapered surface with an inclination angle (A), preferably a tapered surface with an inclination angle (A) of 20-40 degrees, preferably 30 degrees.

2. The locking device for knockdown furniture according to claim 1, wherein a surface of the anchor plug (1) is 0.1-0.4 mm lower than the surface of said one furniture part (FP1), preferably 0.2-0.3 mm.

3. (canceled)

4. The locking device for knockdown furniture according to claim 1, wherein the lock slot (1.4) of the anchor plug (1) is smaller than the insertion slot (1.3) of the anchor plug (1) and a region of the lock slot (1.4) that is connected to the insertion slot (1.3) has a width (w1) that is less than a width (w2) of the lock slot (1.4), preferably
the region of the lock slot (1.4) that is connected to the insertion slot (1.3) has the width (w1) of 3-4 mm, preferably 3.2 mm, and
the lock slot (1.4) has the width (w2) of 3.5-5 mm, preferably 3.5 mm.

5. The locking device for knockdown furniture according to claim 1, wherein the fastening screw (2) comprising:
a head portion (2.1),
a non-threaded portion (2.2) having one end connected to the head portion (2.1),
a stopper (2.3) connected to an other end of the non-threaded portion (2.2), and
a threaded portion (2.4) having one end connected to the stopper (2.3), wherein the head portion (2.1) of the fastening screw (2) has a tapered portion with an inclination angle (B), preferably a tapered portion with an inclination angle (B) of 50-70 degrees, preferably 60 degrees, so that it corresponds to the tapered surface with the inclination angle (A) at the lock slot (1.4).

6. The locking device for knockdown furniture according to claim 5, wherein the non-threaded portion (2.2) of the fastening screw (2) has a diameter (θ) of 3-5 mm, preferably 3-4 mm, more preferably 3.5 mm, and the head portion (2.1) and the stopper (2.3) of the fastening screw (2) are spaced apart from each other by a distance (x) of 10-15 mm, preferably 12 mm.

7. The locking device for knockdown furniture according to claim 5, wherein the one furniture part (FP1) and the other furniture part (FP2) are assembled together using the anchor plug (1) and the fastening screw (2) such that
the anchor plug (1) is embedded into the one furniture part (FP1) with a surface of the anchor plug (1) being slightly lower than the surface of said one furniture part (FP1), preferably 0.1-0.4 mm lower than said one furniture part (FP1), preferably 0.2-0.3 mm,
the fastening screw (2) is fastened to the other furniture part (FP2) with the threaded portion (2.4) embedded into said other furniture part (FP2) and the head portion (2.1), non-threaded portion (2.2) and stopper (2.3) are located on the surface of said other furniture part (FP2) such that the stopper (2.3) abuts against the surface of said other furniture part (FP2),
said one furniture part (FP1) and other furniture part (FP2) are assembled together with the insertion slot (1.3) of the anchor plug (1) fitting the head part (2.1), the non-threaded portion (2.2) and stopper (2.3) of the fastening screw (2) located on the surface of said other furniture part (FP2) such that the surface of the one furniture part (FP1) and the surface of said other furniture part (FP2) are attached and either said one furniture part (FP1) or other furniture part (FP2) is moved in a manner that allows the non-threaded portion (2.2) of the fastening screw (2) to be locked into the lock slot (1.4) of the anchor plug (1).

8. The locking device for knockdown furniture according to claim 1, wherein
the anchor plug (1) is made of a material which is nylon, polyoxymethylene (Pom), polypropylene (PP), acrylonitrile butadiene styrene (ABS) or polyethylene (PE), and
the fastening screw (2) is made of a material which is iron, zinc or alloy.
